(19) United States
(12) Patent Application Publication
(10) Pub. No.: US 2014/0053803 A1
(43) Pub. Date: Feb. 27, 2014

(54) SYSTEM AND METHOD FOR DEACTIVATING A CYLINDER OF AN ENGINE AND REACTIVATING THE CYLINDER BASED ON AN ESTIMATED TRAPPED AIR MASS

(71) Applicant: GM GLOBAL TECHNOLOGY OPERATIONS LLC, Detriot, MI (US)

(72) Inventor: Allen B. Rayl, Waterford, MI (US)

(73) Assignee: GM GLOBAL TECHNOLOGY OPERATIONS LLC, Detroit, MI (US)

(21) Appl. No.: 13/798,451

(22) Filed: Mar. 13, 2013

Related U.S. Application Data
(60) Provisional application No. 61/693,023, filed on Aug. 24, 2012.

(51) Int. Cl. F02D 41/00

(52) U.S. Cl. CPC F02D 41/0087
USPC 123/350

(57) ABSTRACT

A system according to the principles of the present disclosure includes a cylinder activation module and a spark control module. The cylinder activation module selectively deactivates and reactivates a cylinder of an engine. The cylinder activation module deactivates the cylinder after intake air is drawn into the cylinder and before fuel is injected into the cylinder or spark is generated in the cylinder. When the cylinder is reactivated, the spark control module selectively controls a spark plug to generate spark in the cylinder before an intake valve or an exhaust valve of the cylinder is opened.

### CROSS-REFERENCE TO RELATED APPLICATIONS

This application claims the benefit of U.S. Provisional Application No. 61/693,023, filed on Aug. 24, 2012. The disclosure of the above application is incorporated herein by reference in its entirety.

This application is related to United States Patent Application Ser. No. ______ (HDP Ref. No. 8540P-001336) filed on [the same day], Ser. No. ______ (HDP Ref. No. 8540P-001337) filed on [the same day], Ser. No. ______ (HDP Ref. No. 8540P-001342) filed on [the same day], Ser. No. ______ (HDP Ref. No. 8540P-001343) filed on [the same day], Ser. No. ______ (HDP Ref. No. 8540P-001344) filed on [the same day], Ser. No. ______ (HDP Ref. No. 8540P-001345) filed on [the same day], Ser. No. ______ (HDP Ref. No. 8540P-001346) filed on [the same day], Ser. No. ______ (HDP Ref. No. 8540P-001347) filed on [the same day], Ser. No. ______ (HDP Ref. No. 8540P-001348) filed on [the same day], Ser. No. ______ (HDP Ref. No. 8540P-001349) filed on [the same day], Ser. No. ______ (HDP Ref. No. 8540P-001350) filed on [the same day], Ser. No. ______ (HDP Ref. No. 8540P-001351) filed on [the same day], Ser. No. ______ (HDP Ref. No. 8540P-001352) filed on [the same day], Ser. No. ______ (HDP Ref. No. 8540P-001359) filed on [the same day], Ser. No. ______ (HDP Ref. No. 8540P-001362) filed on [the same day], Ser. No. ______ (HDP Ref. No. 8540P-001363) filed on [the same day], Ser. No. ______ (HDP Ref. No. 8540P-001364) filed on [the same day], and Ser. No. ______ (HDP Ref. No. 8540P-001368) filed on [the same day]. The entire disclosures of the above applications are incorporated herein by reference.

### FIELD

The present disclosure relates to deactivating a cylinder of an engine and reactivating the cylinder based on an estimated mass of air trapped in the cylinder.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines combust an air and fuel mixture within cylinders to drive pistons, which produces drive torque. Air flow into the engine is regulated via a throttle. More specifically, the throttle adjusts throttle area, which increases or decreases air flow into the engine. As the throttle area increases, the air flow into the engine increases. A fuel control system adjusts the rate that fuel is injected to provide a desired air/fuel mixture to the cylinders and/or to achieve a desired torque output. Increasing the amount of air and fuel provided to the cylinders increases the torque output of the engine.

In spark-ignition engines, spark initiates combustion of an air/fuel mixture provided to the cylinders. In compression-ignition engines, compression in the cylinders combusts the air/fuel mixture provided to the cylinders. Spark timing and air flow may be the primary mechanisms for adjusting the torque output of spark-ignition engines, while fuel flow may be the primary mechanism for adjusting the torque output of compression-ignition engines.

Under some circumstances, one or more cylinders of an engine may be deactivated to decrease fuel consumption. For example, one or more cylinders may be deactivated when the engine can produce a requested amount of torque while the one or more cylinders are deactivated. Deactivation of a cylinder may include disabling opening intake and exhaust valves of the cylinder and disabling fueling of the cylinder.

### SUMMARY

A system according to the principles of the present disclosure includes a cylinder activation module and a spark control module. The cylinder activation module selectively deactivates and reactivates a cylinder of an engine. The cylinder activation module deactivates the cylinder after intake air is drawn into the cylinder and before fuel is injected into the cylinder or spark is generated in the cylinder. When the cylinder is reactivated, the spark control module selectively controls a spark plug to generate spark in the cylinder before an intake valve or an exhaust valve of the cylinder is opened.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine system according to the principles of the present disclosure;

FIG. 2 is a functional block diagram of an example control system according to the principles of the present disclosure; and

FIGS. 3 and 4 are flowcharts illustrating an example control method according to the principles of the present disclosure.

### DETAILED DESCRIPTION

An engine control system may deactivate a cylinder of an engine after an air/fuel mixture is combusted in the cylinder and before exhaust gas is expelled from the cylinder. As a result, all of the exhaust gas that results from combustion is trapped in the cylinder along with a small quantity of unburned fuel. The trapped gas may be referred to as a full burned charge. The trapped gas acts as a spring as a piston in the cylinder moves between its topmost position, referred to as top dead center (TDC), and its bottommost position, referred to as bottom dead center (BDC).

When the piston moves from BDC to TDC, the engine uses energy as the piston compresses the trapped gas. When the piston moves from TDC to BDC, the engine recoups some of the energy since the trapped gas biases the piston towards BDC. However, the engine does not recoup all of the energy, which results in a pumping loss that has a negative effect on fuel economy. In addition, the high pressure of the trapped gas results in engine vibrations as the piston moves within the cylinder, compressing and expanding the trapped gas.

An engine control system may deactivate a cylinder of an engine after exhaust gas is expelled from the cylinder and before an intake valve is opened to draw fresh air into the cylinder. As a result, residual exhaust and a small quantity of unburned fuel are trapped within the cylinder. The trapped gas may be referred to as a small burned charge. Trapping a small burned charge improves fuel economy and reduces engine vibrations relative to trapping a full burned charge. However, the pressure in the cylinder trapping the small burned charge may be less than the pressure in a crankcase of the engine. Thus, a vacuum may be created in the cylinder that causes crankcase oil to flow past piston rings and into the cylinder. Some of the crankcase oil may be combusted when the cylinder is reactivated.

An engine control system and method according to the principles of the present disclosure deactivates a cylinder of an engine after fresh air is drawn into the cylinder and before fuel is injected into the cylinder or spark is generated in the cylinder. As a result, fresh air, a small quantity of residual exhaust, and a small quantity of unburned fuel are trapped in the cylinder. Trapping fresh air improves fuel economy and reduces engine vibrations relative to trapping a full burned charge. In addition, the pressure in a cylinder containing fresh air is greater than the pressure in a cylinder containing a small burned charge. Thus, trapping fresh air reduces oil consumption relative to trapping a small burned charge.

An engine control system and method according to the principles of the present disclosure estimates the amount of fresh air, residual exhaust, and unburned fuel trapped in the cylinder when the cylinder is reactivated. If the estimated amount is sufficient for combustion, the cylinder is reactivated by injecting fuel into the cylinder and generating spark in the cylinder before opening the intake or exhaust valves. Thus, the cylinder is able to generate torque faster relative to other reactivation techniques.

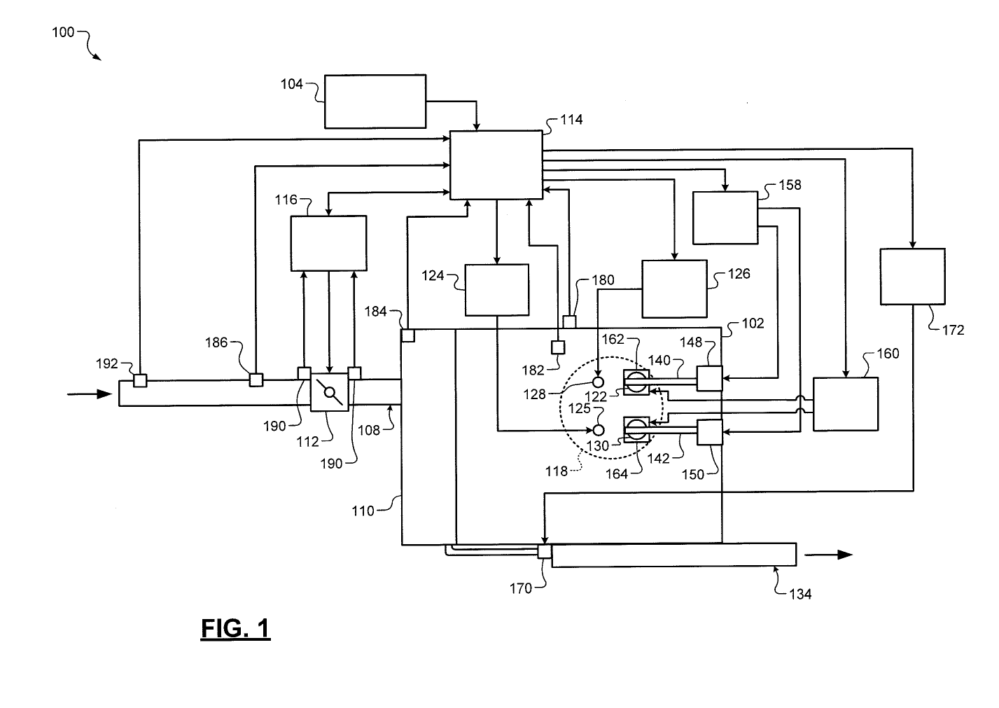

Referring now to FIG. 1, an engine system 100 includes an engine 102 that combusts an air/fuel mixture to produce drive torque for a vehicle based on driver input from a driver input module 104. Air is drawn into the engine 102 through an intake system 108. The intake system 108 includes an intake manifold 110 and a throttle valve 112. The throttle valve 112 may include a butterfly valve having a rotatable blade. An engine control module (ECM) 114 controls a throttle actuator module 116, which regulates opening of the throttle valve 112 to control the amount of air drawn into the intake manifold 110.

Air from the intake manifold 110 is drawn into cylinders of the engine 102. While the engine 102 may include multiple cylinders, for illustration purposes a single representative cylinder 118 is shown. For example only, the engine 102 may include 2, 3, 4, 5, 6, 8, 10, and/or 12 cylinders. The ECM 114 may selectively deactivate some of the cylinders, which may improve fuel economy under certain engine operating conditions.

The engine 102 may operate using a four-stroke cycle. The four strokes, described below, are named the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes.

During the intake stroke, air from the intake manifold 110 is drawn into the cylinder 118 through an intake valve 122. The ECM 114 controls a fuel actuator module 124, which regulates fuel injection to achieve a desired air/fuel ratio. A fuel injector 125 injects fuel directly into the cylinder 118 or into a mixing chamber associated with the cylinder 118. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression in the cylinder 118 ignites the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. The timing of the spark may be specified relative to when the piston is at TDC.

The spark actuator module 126 may be controlled by a timing signal specifying how far before or after TDC to generate the spark. Because piston position is directly related to crankshaft rotation, operation of the spark actuator module 126 may be synchronized with crankshaft angle. In various implementations, the spark actuator module 126 may halt provision of spark to deactivated cylinders.

Generating the spark may be referred to as a firing event. The spark actuator module 126 may have the ability to vary the timing of the spark for each firing event. The spark actuator module 126 may even be capable of varying the spark timing for a next firing event when the spark timing signal is changed between a last firing event and the next firing event. In various implementations, the engine 102 may include multiple cylinders and the spark actuator module 126 may vary the spark timing relative to TDC by the same amount for all cylinders in the engine 102.

During the combustion stroke, the combustion of the air/fuel mixture drives the piston down, thereby driving the crankshaft. The combustion stroke corresponds to the piston moving down from TDC to BDC.

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118).

The time at which the intake valve 122 is opened may be varied with respect to piston TDC by an intake cam phaser 148. The time at which the exhaust valve 130 is opened may be varied with respect to piston TDC by an exhaust cam phaser 150. A phaser actuator module 158 may control the intake cam phaser 148 and the exhaust cam phaser 150 based on signals from the ECM 114.

The ECM 114 may deactivate the cylinder 118 by instructing a valve actuator module 160 to deactivate opening of the intake valve 122 and/or the exhaust valve 130. The valve actuator module 160 deactivates opening of the intake valve 122 by actuating an intake valve actuator 162. The valve actuator module 160 deactivates opening of the exhaust valve 130 by actuating an exhaust valve actuator 164. In one example, the valve actuators 162, 164 include solenoids that deactivate opening of the valves 122, 130 by decoupling cam followers from the camshafts 140, 142. In this example, opening the valves 122, 130 may only be deactivated when the piston is at TDC and the cam followers are on the base circle of the cam lobe so that any load on the valve actuators 160, 162 is minimal to allow actuator movement.

In another example, the valve actuators 162, 164 are electromagnetic or electrohydraulic actuators that control the lift, timing, and duration of the valves 122, 130 independent from the camshafts 140, 142. In this example, opening of the valves 122, 130 may be deactivated anytime during the piston stroke. In addition, the camshafts 140, 142, the cam phasers 148, 150, and the phaser actuator module 158 may be omitted.

The engine system 100 may include an exhaust gas recirculation (EGR) valve 170, which selectively redirects exhaust gas back to the intake manifold 110. The EGR valve 170 may be controlled by an EGR actuator module 172.

The position of the crankshaft may be measured using a crankshaft position (CKP) sensor 180. The temperature of the engine coolant may be measured using an engine coolant temperature (ECT) sensor 182. The ECT sensor 182 may be located within the engine 102 or at other locations where the coolant is circulated, such as a radiator (not shown).

The pressure within the intake manifold 110 may be measured using a manifold absolute pressure (MAP) sensor 184. In various implementations, engine vacuum, which is the difference between ambient air pressure and the pressure within the intake manifold 110, may be measured. The mass flow rate of air flowing into the intake manifold 110 may be measured using a mass air flow (MAF) sensor 186. In various implementations, the MAF sensor 186 may be located in a housing that also includes the throttle valve 112.

The throttle actuator module 116 may monitor the position of the throttle valve 112 using one or more throttle position sensors (TPS) 190. The ambient temperature of air being drawn into the engine 102 may be measured using an intake air temperature (IAT) sensor 192. The ECM 114 may use signals from the sensors to make control decisions for the engine system 100.

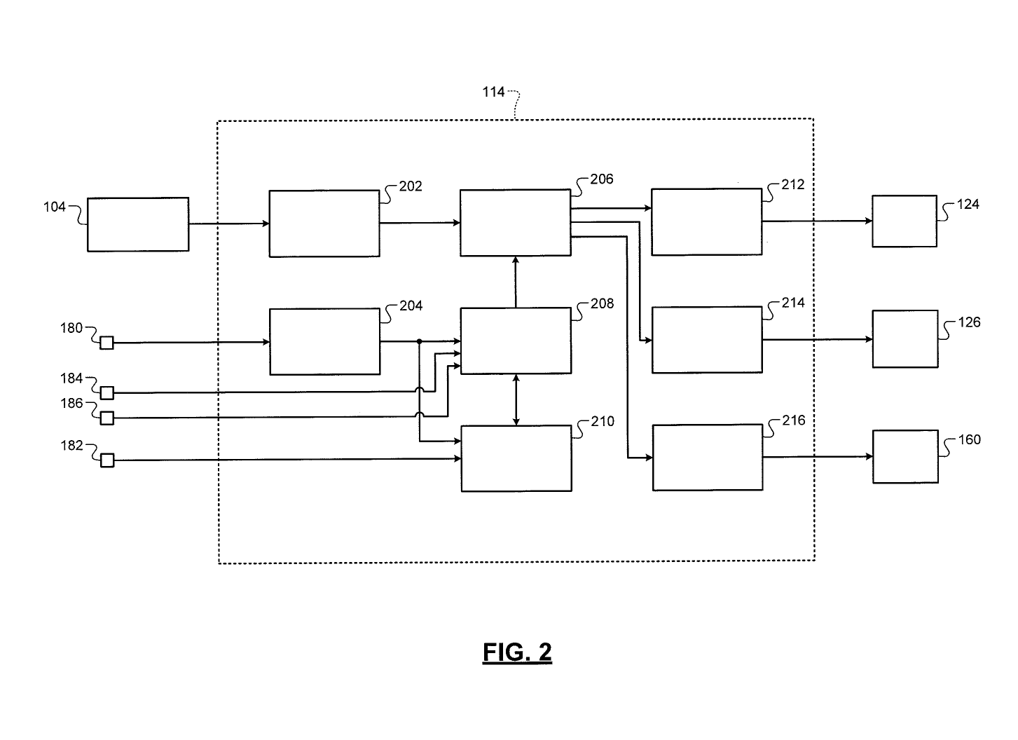

Referring now to FIG. 2, an example implementation of the ECM 114 includes a driver torque module 202, an engine speed module 204, a cylinder activation module 206, a cylinder charge module 208, and a crankcase gas module 210. The driver torque module 202 determines a driver torque request based on the driver input from the driver input module 104. The driver input may be based on a position of an accelerator pedal. The driver input may also be based on cruise control, which may be an adaptive cruise control system that varies vehicle speed to maintain a predetermined following distance. The driver torque module 202 may store one or more mappings of accelerator pedal position to desired torque, and may determine the driver torque request based on a selected one of the mappings. The driver torque module 202 outputs the driver torque request.

The engine speed module 204 determines engine speed. The engine speed module 204 may determine engine speed based on input received from the CKP sensor 180. The engine speed module 204 may determine engine speed based on an amount of crankshaft rotation between tooth detections and the corresponding period. The engine speed module 204 outputs the engine speed.

The cylinder activation module 206 deactivates and reactivates one or more cylinders of the engine 102 based on the driver torque request. The cylinder activation module 206 may deactivate one or more cylinders when the engine 102 can satisfy the driver torque request while the cylinder(s) are deactivated. The cylinder activation module 206 may reactivate one or more cylinders when the engine 102 cannot satisfy the driver torque request while the cylinder(s) are deactivated.

The cylinder activation module 206 deactivates the cylinder 118 by sending instructions to a fuel control module 212, a spark control module 214, and a valve control module 216. In turn, the fuel control module 212 instructs the fuel actuator 124 to stop injecting fuel into the cylinder 118 and the spark control module 214 instructs the spark actuator module 126 to stop generating spark in the cylinder 118. In addition, the valve control module 216 instructs the valve actuator module 160 to close the valves 122, 130 and/or to stop opening the valves 122, 130.

The cylinder activation module 206 may deactivate the cylinder 118 after intake air is drawn into the cylinder 118 and before the fuel injector 125 injects fuel into the cylinder 118 or the spark plug 128 generates spark in the cylinder 118. Deactivating the cylinder 118 at this time traps fresh intake air in the cylinder 118 while the cylinder 118 is deactivated. The cylinder activation module 206 may deactivate the cylinder 118 when the intake valve 122 is closed at the end of an intake stroke.

When the valve actuator 162 is an electromagnetic or electrohydraulic actuator, the cylinder activation module 206 may close the intake valve 122 and deactivate the cylinder 118 before the intake stroke is complete. The time at which the intake valve 122 is closed may be adjusted to control the amount of air trapped in the cylinder 118. The amount of air trapped in the cylinder 118 may be controlled to minimize the pressure within the cylinder 118 while ensuring that there is enough air in the cylinder 118 to allow adequate combustion and to prevent crankcase oil from entering the cylinder 118. Minimizing the pressure within the cylinder 118 reduces the pumping losses associated with the cylinder 118 while the cylinder 118 is deactivated, which improves the fuel economy of the engine 102.

The cylinder charge module 208 estimates a mass of a charge within a cylinder of the engine 102. The cylinder charge may include intake air, unburned fuel, and/or exhaust. The cylinder charge module 208 may estimate the mass of the charge in each cylinder of the engine 102 once per engine cycle.

The cylinder charge module 208 may estimate the mass of the charge trapped in the cylinder 118 when the intake valve 122 is closed and the cylinder 118 is deactivated. Thus, the cylinder charge may include air, unburned fuel, and residual exhaust. The cylinder charge module 208 may estimate the mass of each component of the cylinder charge. The cylinder charge module 208 may estimate the mass of air initially trapped in the cylinder 118 based on the manifold pressure, the mass flow rate of intake air, the engine speed, the throttle area, and/or the cam phaser positions.

When the cylinder 118 is deactivated, the cylinder charge module 208 adjusts the estimated mass of the cylinder charge as the piston moves between TDC and BDC. As the piston moves from BDC to TDC, the pressure within the cylinder 118 increases relative to the pressure within a crankcase of the engine 102. This causes a portion of the cylinder charge to flow past piston rings and to the crankcase, referred to as blow-by. Thus, the estimated mass of the cylinder charge may be decreased. As the piston moves from TDC to BDC, the cylinder pressure decreases relative to the crankcase pressure. This causes a portion of the crankcase gas to flow past the piston rings and into the cylinder 118. Thus, the estimated mass of the cylinder charge may be increased.

The crankcase gas module 210 estimates the mass of gas within the crankcase. The crankcase gas module 210 may estimate the mass of the crankcase gas when the intake valve 122 is closed and the cylinder 118 is deactivated. At this time, the cylinder charge is primarily made up of air. Thus, the crankcase gas module 210 may estimate the mass of the crankcase gas based on the estimated mass of air trapped in the cylinder 118 without considering the mass of the other constituents of the cylinder charge.

In addition, the crankcase gas module 210 may estimate the mass of the crankcase gas based on the engine speed, the engine coolant temperature, and/or the pressure in the crankcase. The mass of the crankcase gas may be estimated based on the engine coolant temperature since the amount of flow past the piston rings increases as the engine temperature decreases and the effectiveness of the piston ring seal decreases. The crankcase gas module 210 may estimate the crankcase pressure based on the amount of flow past the piston rings and/or the amount of flow through a pressure relief valve. The pressure relief valve releases gas from the crankcase when the crankcase pressure is greater than a predetermined pressure. The release gas is directed to the intake system 108.

The cylinder activation module 206 reactivates the cylinder 118 by sending instructions to the fuel control module 212, the spark control module 214, and the valve control module 216. In turn, the fuel control module 212 instructs the fuel actuator 124 to resume injecting fuel into the cylinder 118 and the spark control module 214 instructs the spark actuator module 126 to resume generating spark in the cylinder 118. In addition, the valve control module 216 instructs the valve actuator module 160 to resume opening the valves 122, 130.

The cylinder activation module 206 may reactivate the cylinder 118 in a number of ways. The cylinder activation module 206 may open the intake valve 122 first, before opening the exhaust valve 130 or injecting fuel into the cylinder 118 and generating spark in the cylinder 118. The cylinder activation module 206 may open the exhaust valve 130 first, before opening the intake valve 122 or injecting fuel into the cylinder 118 and generating spark in the cylinder 118. The cylinder activation module 206 may inject fuel into the cylinder 118 and generate spark in the cylinder 118 first, before opening the valves 122, 130.

The cylinder activation module 206 opens the intake valve 122 first when a maximum pressure in the cylinder 118 is less than a first pressure, indicating that a minimal amount of charge will be pushed back to the intake manifold 110 if the intake valve 122 is opened. The maximum pressure is the pressure in the cylinder 118 when the piston is at TDC. The maximum pressure may be estimated based on the volume, temperature, and mass of the charge trapped in the cylinder 118. The first pressure may be a predetermined value (e.g., 5 kilopascals).

If the maximum pressure is greater than or equal to the first pressure, the cylinder activation module 206 compares the estimated mass of air trapped within the cylinder 118 to a first mass. The first mass may be a predetermined value (e.g., 50 milligrams). The cylinder activation module 206 injects fuel into the cylinder 118 and generates spark in the cylinder 118 first when the estimated mass of trapped air is greater than the first mass, indicating that the trapped air mass is adequate for combustion. The cylinder activation module 206 opens the exhaust valve 130 first when the estimated mass of trapped air is less than or equal to the first mass.

When the cylinder activation module 206 injects fuel into the cylinder 118 and generates spark in the cylinder 118 first, the cylinder activation module 206 opens the exhaust valve 130 to expel exhaust before opening the intake valve 122 to draw in fresh intake air. In this regard, the cylinder activation module 206 reactivates the exhaust valve 130 first. Similarly, the cylinder activation module 206 deactivates the exhaust valve 130 first since the exhaust valve 130 is the first of the valves 122, 130 that is not opened normally when the cylinder 118 is deactivated. Since the cylinder activation module 206 may deactivate and reactivate the same valve (i.e., the exhaust valve 130) first, only one solenoid may be required to deactivate and reactivate the cylinder 118. Thus, if the valve actuators 162, 164 include solenoids, one of the valve actuators 162, 164 may be omitted, which reduces vehicle costs.

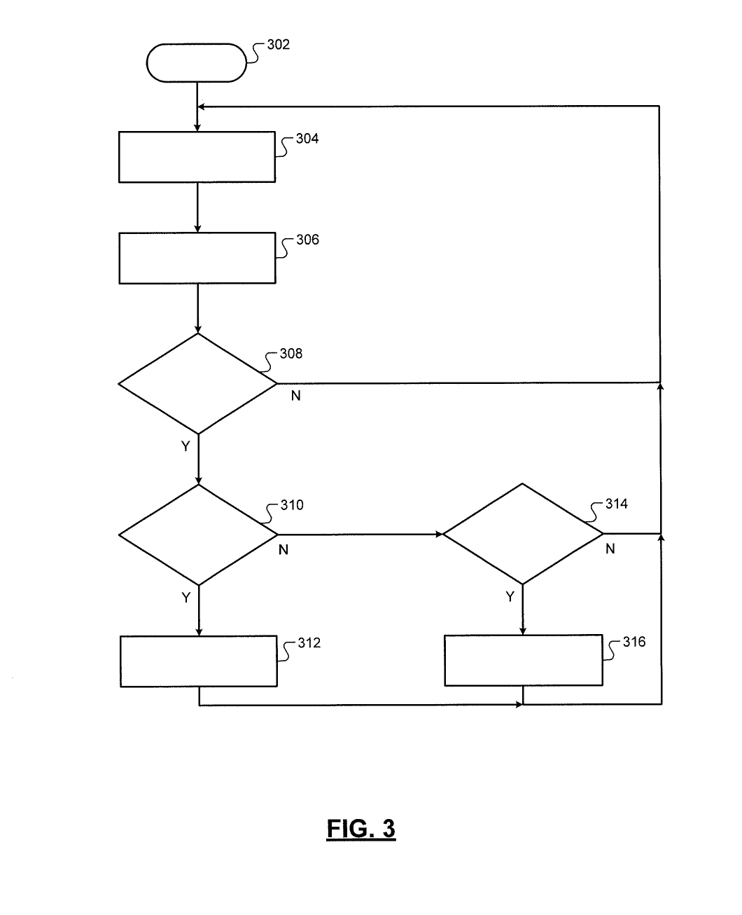

Referring now to FIG. 3, a method for estimating a mass of a charge within a cylinder begins at 302. The cylinder charge may include intake air, unburned fuel, and/or exhaust. The method may estimate the mass of the charge in each cylinder of an engine once per engine cycle.

At 304, the method estimates the mass of the cylinder charge. The method may estimate the mass of a charge trapped in a cylinder when an intake valve of the cylinder is closed after a piston in the cylinder completes an intake stroke. Thus, the cylinder charge may include trapped air, unburned fuel, and residual exhaust. The method may estimate the mass of each component of the cylinder charge. The method may estimate the mass of air trapped in the cylinder based on a manifold pressure, a mass flow rate of intake air, engine speed, a throttle area, and/or cam phaser positions.

At 306, the method estimates the mass of gas within a crankcase of the engine. The method may estimate the mass of the crankcase gas based on the estimated mass of air trapped in the cylinder, the engine speed, an engine coolant temperature, and/or the pressure in the crankcase. The method may estimate the crankcase pressure based on the amount of flow past piston rings and/or the amount of flow through a pressure relief valve that selectively releases gas from the crankcase based on the crankcase pressure.

At 308, the method determines whether the cylinder is deactivated. If the cylinder is deactivated, the method continues at 310. Otherwise, the method continues at 304. At 310 through 316, the method estimates changes in the estimated mass of the charge trapped in the deactivated cylinder and the estimated mass of the gas in the crankcase as gas is exchanged between the cylinder and the crankcase due to blow-by.

The method may estimate changes in the estimated mass of the charge trapped in the deactivated cylinder and the estimated mass of the gas in the crankcase based on the amount of flow past the piston rings. The method may estimate the amount of flow past the piston rings using a theoretical model and/or an empirical model. The theoretical model may be used to estimate the amount of flow past the piston rings based on an effective orifice size and a pressure difference. The effective orifice size is the size of the gap between the piston rings and the piston bore. The effective orifice size may be determined based on the engine geometry and engine operating conditions such as the engine coolant temperature.

The pressure difference is the difference between the crankcase pressure and the cylinder pressure. The crankcase pressure may be estimated as described above. The cylinder pressure may be estimated based on the volume of the cylinder and the temperature and mass of the cylinder charge. The cylinder volume may be determined based on the engine geometry. The cylinder pressure may be estimated based on the estimated mass of the trapped cylinder charge from a previous iteration.

The empirical model may be developed by measuring the crankcase pressure and the cylinder pressure to determine the amount of flow past the piston rings under various engine operating conditions. The crankcase pressure and the cylinder pressure may be measured when an engine is mounted to a dynamometer in a laboratory. A relationship between the crankcase pressure, the cylinder pressure, and the engine operating conditions may be captured in the form of an equation and/or a lookup table.

The empirical model may also be used to estimate the mass of air trapped in the cylinder. When a cylinder is initially deactivated, the mass of air trapped in the cylinder may be estimated based on engine operating parameters such as the mass flow rate of intake air, the engine speed, the throttle area, and/or cam phaser positions. However, as the cylinder is deactivated, the mass of air trapped in the cylinder, and the portion of the cylinder charge that is made up of air, changes due to blow-by.

The empirical model for estimating the mass of air trapped in the cylinder may be developed by injecting fuel into the cylinder after the cylinder has been deactivated for a predetermined number (e.g., 3) of engine cycles. The fuel may then be combusted and exhausted, and the air/fuel ratio of the exhaust may be measured. The amount of air trapped in the cylinder after the predetermined number of engine cycles may then be determined based on the amount of fuel injected and the measured air/fuel ratio. Engine operating conditions may be measured while the empirical model is developed, and a relationship between the engine operating conditions and the mass of air trapped in the cylinder may be captured in the form of an equation and/or a lookup table.

At 310, the method determines whether the piston is at TDC. If the piston is at TDC, the method continues at 312. Otherwise, the method continues at 314. At 312, the method estimates a decrease in the mass of the trapped cylinder charge.

At 314, the method determines whether the piston is at BDC. If the piston is at BDC, the method continues at 316. Otherwise, the method continues at 304. At 316, the method estimates an increase in the mass of the trapped cylinder charge.

For simplicity, FIG. 3 illustrates a method for estimating the mass of a charge in one cylinder of an engine. However, the method depicted in FIG. 3 may be repeated for each cylinder in an engine. In addition, the mass of the crankcase gas may be adjusted based on the estimated mass of the charge in each cylinder of an engine.

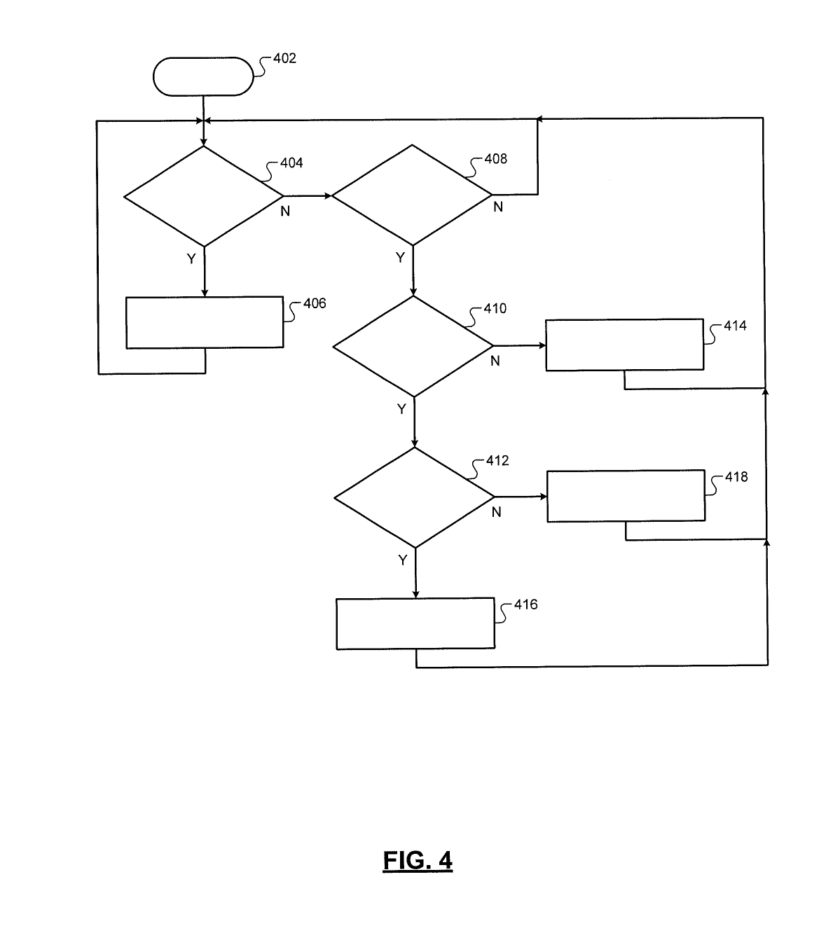

Referring now to FIG. 4, a method for deactivating a cylinder of an engine and reactivating the cylinder based on an estimated mass of air trapped in the cylinder begins at 402. At 404, the method determines whether a cylinder deactivation request is generated. In various implementations, a cylinder deactivation request is generated when the engine can produce a requested amount of torque while the one or more cylinders of the engine are deactivated. If a cylinder deactivation request is generated, the method continues at 406. Otherwise, the method continues at 408.

At 406, the method deactivates the cylinder after a piston in the cylinder completes an intake stroke and an intake valve of the cylinder is closed, and before an exhaust valve of the cylinder is opened. This traps fresh intake air within the cylinder as the cylinder is deactivated.

The method may close the intake valve and deactivate the cylinder before the intake stroke is complete when, for example, the intake valve is controlled using a valve actuator such as an electromagnetic or electrohydraulic actuator. The time at which the intake valve is closed may be adjusted to control the amount of air trapped in the cylinder. The amount of air trapped in the cylinder may be controlled to minimize the pressure within the cylinder while ensuring that there is enough air in the cylinder to allow adequate combustion and to prevent crankcase oil from entering the cylinder.

At 408, the method determines whether a cylinder reactivation request is generated. In various implementations, a cylinder reactivation request is generated when the engine cannot produce a requested amount of torque while the one or more cylinders of the engine are deactivated. If a cylinder reactivation request is generated, the method continues at 410. Otherwise, the method continues at 404.

At 410, the method determines whether a maximum pressure in the cylinder is greater than or equal to a first pressure. The maximum pressure in the cylinder may be the pressure in the cylinder when the piston is at TDC. The maximum pressure may be estimated based on the volume, composition, temperature, and mass of the trapped cylinder charge. The mass of the trapped cylinder charge may be estimated as described above with reference to FIG. 3. The first pressure may be a predetermined value (e.g., 5 kilopascals). If the maximum pressure is greater than or equal to the first pressure, the method continues at 412. If the maximum pressure is less than the first pressure, indicating that a minimal amount of charge will be pushed back to an intake manifold of the engine if the intake valve is opened, the method continues at 414.

At 414, the method reactivates the intake valve first, before reactivating the exhaust valve or injecting fuel into the cylinder and generating spark in the cylinder. In other words, the method draws air into the cylinder before exhausting the charge from the cylinder or injecting fuel into the cylinder and generating spark in the cylinder.

At 412, the method determines whether the mass of air trapped in the cylinder is greater than a first mass. The mass of air trapped in the cylinder may be estimated as described above with reference to FIG. 3. The first mass may be a predetermined value (e.g., 50 milligrams). If the mass of air trapped in the cylinder is greater than the first mass, the method continues at 416. Otherwise, the method continues at 418.

At 418, the method reactivates the exhaust valve first, before reactivating the intake valve or injecting fuel into the cylinder and generating spark in the cylinder. In other words, the method exhausts the charge from the cylinder before drawing air into the cylinder or injecting fuel into the cylinder and generating spark in the cylinder.

At 416, the method first injects fuel into the cylinder and generates spark in the cylinder before reactivating the intake valve or the exhaust valve. In other words, the method injects fuel into the cylinder and generates spark in the cylinder before drawing air into the cylinder or exhausting the charge from the cylinder.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); a discrete circuit; an integrated circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be partially or fully implemented by one or more computer programs executed by one or more processors. The computer programs include processor-executable instructions that are stored on at least one non-transitory tangible computer readable medium. The computer programs may also include and/or rely on stored data. Non-limiting examples of the non-transitory tangible computer readable medium include nonvolatile memory, volatile memory, magnetic storage, and optical storage.

What is claimed is:

1. A system comprising:
a cylinder activation module that:
selectively deactivates and reactivates a cylinder of an engine; and
deactivates the cylinder after intake air is drawn into the cylinder and before fuel is injected into the cylinder or spark is generated in the cylinder; and
a spark control module that, when the cylinder is reactivated, selectively controls a spark plug to generate spark in the cylinder before an intake valve or an exhaust valve of the cylinder is opened.

2. The system of claim 1 further comprising a fuel control module that, when the cylinder is reactivated, selectively controls a fuel injector to inject fuel into the cylinder before the intake valve or the exhaust valve is opened and before spark is generated in the cylinder.

3. The system of claim 2 wherein the spark control module selectively generates spark in the cylinder before the intake valve or the exhaust valve is opened when a pressure in the cylinder is greater than a first pressure.

4. The system of claim 3 wherein the cylinder activation module estimates the pressure in the cylinder based on a volume, a temperature, and a mass of a charge trapped within the cylinder when the cylinder is deactivated.

5. The system of claim 3 wherein the spark control module generates spark in the cylinder before the intake valve or the exhaust valve is opened when a mass of air within the cylinder is greater than a first mass.

6. The system of claim 5 further comprising a cylinder charge module that estimates a mass of a charge, including the mass of air, trapped within the cylinder when the cylinder is deactivated.

7. The system of claim 6 wherein the cylinder charge module estimates the mass of air trapped within the cylinder when the cylinder is deactivated based on at least one of a manifold pressure, a mass flow rate of intake air, engine speed, a throttle area, and cam phaser positions.

8. The system of claim 6 wherein the cylinder charge module adjusts the estimated mass of the charge based on an amount of flow between the cylinder and a crankcase of the engine as a piston moves within the cylinder when the cylinder is deactivated.

9. The system of claim 8 wherein the cylinder charge module estimates the amount of flow between the cylinder and the crankcase based on a position of the piston and a mass of gas trapped within the crankcase when the cylinder is deactivated.

10. The system of claim 9 further comprising a crankcase gas module that estimates the mass of gas trapped within the crankcase based on at least one of engine speed, an engine coolant temperature, and a pressure in the crankcase.

11. A method comprising:
selectively deactivating and reactivating a cylinder of an engine; and
deactivating the cylinder after intake air is drawn into the cylinder and before fuel is injected into the cylinder or spark is generated in the cylinder; and
when the cylinder is reactivated, selectively controlling a spark plug to generate spark in the cylinder before an intake valve or an exhaust valve of the cylinder is opened.

12. The method of claim 11 further comprising, when the cylinder is reactivated, selectively controlling a fuel injector to inject fuel into the cylinder before the intake valve or the exhaust valve is opened and before spark is generated in the cylinder.

13. The method of claim 12 further comprising selectively generating spark in the cylinder before the intake valve or the exhaust valve is opened when a pressure in the cylinder is greater than a first pressure.

14. The method of claim 13 further comprising estimating the pressure in the cylinder based on a volume, a temperature, and a mass of a charge trapped within the cylinder when the cylinder is deactivated.

15. The method of claim 13 further comprising generating spark in the cylinder before the intake valve or the exhaust valve is opened when a mass of air within the cylinder is greater than a first mass.

16. The method of claim 15 further comprising estimating a mass of a charge, including the mass of air, trapped within the cylinder when the cylinder is deactivated.

17. The method of claim 16 further comprising estimating the mass of air trapped within the cylinder when the cylinder is deactivated based on at least one of a manifold pressure, a mass flow rate of intake air, engine speed, a throttle area, and cam phaser positions.

18. The method of claim 16 further comprising adjusting the estimated mass of the charge based on an amount of flow between the cylinder and a crankcase of the engine as a piston moves within the cylinder when the cylinder is deactivated.

19. The method of claim 18 further comprising estimating the amount of flow between the cylinder and the crankcase based on a position of the piston and a mass of gas trapped within the crankcase when the cylinder is deactivated.

20. The method of claim 19 further comprising estimating the mass of gas trapped within the crankcase based on at least one of engine speed, an engine coolant temperature, and a pressure in the crankcase.
